(19) United States
(12) Patent Application Publication
(10) Pub. No.: US 2007/0260036 A1
(43) Pub. Date: Nov. 8, 2007

(54) High Adhesive Polyimide Film and Method for Producing Same

(76) Inventors: Hisayasu Kaneshiro, Kyoto (JP); Takashi Kikuchi, Shiga (JP)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/662,809

(22) PCT Filed: Sep. 9, 2005
(86) PCT No.: PCT/JP05/16583

§ 371 Date: Mar. 13, 2007

(30) Foreign Application Priority Data
Sep. 15, 2004 (JP) 2004-268783

(51) Int. Cl. C08G 69/26

(52) U.S. Cl. 528/353

(57) ABSTRACT

Disclosed is a polyimide film having good adherability to an adhesive, especially to a polyimide adhesive. Specifically, disclosed is a non-thermoplastic polyimide film whose raw material is composed of a diamine essentially containing 2,2-bisaminophenoxylphenylpropane and praphenylene diamine, and an acid dianhydride component essentially containing a pyromellitic dianhydride and 3,3′,4,4′-benzophenone tetracarboxylic dianhydride. Thus non-thermoplastic polyimide film is characterized by having an average birefringence of less than 0.14.

### TECHNICAL FIELD

The present invention relates to a non-thermoplastic polyimide film having a high adherability with respect to an adhesive, especially to a thermoplastic polyimide, and being preferably applicable to a two-layered CCL.

### BACKGROUND ART

The recent trends toward lighter, smaller, and higher-density electronic products have increased the demand for various printing boards. In particular, the demand for flexible laminates (also referred to as “flexible printing circuit boards (FPCs)”) has shown a notable increase. A flexible laminate is constituted from an insulating film and a circuit formed from a metal foil disposed on the film.

Typically, a flexible laminate is produced by bonding a metal foil onto a surface of a substrate with an adhesive material of various kinds under heating and pressure, the substrate being a flexible film made from an insulating material of various kinds. Polyimide films and the like are preferred as the insulating flexible film, and thermosetting adhesives such as epoxy and acrylic adhesives are typically used as the adhesive material. Hereinafter, FPCs made using thermosetting adhesives are also referred to as “three-layer FPCs”.

Thermosetting adhesives are advantageous in that bonding at relatively low temperatures is possible. However, requirements for properties, such as heat resistance, flexibility, and electrical reliability, are becoming more stringent, and it is possible that three-layer FPCs using thermosetting adhesives will have difficulty in meeting these stringent requirements. In order to overcome this problem, FPCs (hereinafter also referred to as “two-layer FPCs”) using thermoplastic polyimide as the bonding layer or made by directly forming a metal layer on the insulating film have been proposed. The two-layer FPCs have properties superior to those of the three-layer FPCs, and the demand for the two-layer FPCs is expected to grow in the future.

In general, the polyimide films, which are low in adherability (i.e., a property that allows adhering thereto with high adhesiveness) with respect to the thermoplastic polyimides, require adherability-enhancing treatment. Examples of the adherability-enhancing treatment encompass surface treatment such as plasma treatment, corona treatment, and the like, and addition of a coupling agent or a particular metal component in the polyimide films. This leads to problems of high cost and deterioration in film property. (Patent Citations 1 to 3) However, polyimide films are low in adherability to thermoplastic polyimide-based adhesive materials, and the adherability of the polyimide films is still insufficient even after such treatment.

Moreover, there is a demand for better dimensional stability, water absorbing property, and mechanical property, recently. For example, the improvement of these properties is achieved by arranging the polyimide films to have a block component made of a rigid non-thermoplastic polyimide prepared from paraphenylenediamine and pyromellitic dianhydride. The polyimide films of this arrangement are difficult to produce industrially with high stability due to poor storage stability of a polyimide precursor solution, unless the storage stability of the polyimide precursor solution is improved by molecular weight control or the other treatment. Moreover, these citations do not disclose a non-thermoplastic polyimide film having a characteristic composition of the present invention, and do not describe that the characteristic composition of the present invention improves the adherability. (Patent Citations 4 and 5)

A polyimide film has been disclosed, which is prepared from a polyamic acid made by co-polymerizing 3,3′,4,4-benzophenonetetracarboxylic dianhydride, pyromellitic dianhydride, phenylenediamine, and bisaminophenoxyphenylpropane. (Patent Citation 4). This polyimide film, however, aims for balancing various properties of the film to be suitable for use in TAB tapes. It is not disclosed at all that a film having a particular birefringence can be adhered with a higher adhesiveness with a metal foil by using an adhesive. Moreover, the film disclosed therein is different from a non-thermoplastic polyimide film of the present invention having a birefringence of greater than 0.14.

[Patent Citation 1] Japanese Unexamined Patent Application Publication, Tokukaihei, No. 5-222219

[Patent Citation 2] Japanese Unexamined Patent Application Publication, Tokukaihei, No. 6-32926

[Patent Citation 3] Japanese Unexamined Patent Application Publication, Tokukaihei, No. 11-158276

[Patent Citation 4] Japanese Unexamined Patent Application Publication, Tokukai, No. 2000-80178

[Patent Citation 5] Japanese Unexamined Patent Application Publication, Tokukai, No. 2000-119521

### DISCLOSURE OF INVENTION

[Technical Problem]

In view of the aforementioned problems, an object of the present invention is to provide a polyimide film to which adhesives are adherable, especially, polyimide-based adhesives are adherable.

[Technical Solution]

As a result of diligent studies to attain the object, the inventors of the present invention specified a structure of a polyimide and designed a polyimide film such that the polyimide film has an average birefringence less than or equal to a particular value. The inventors found that this polyimide exhibits adherability with respect to adhesives, especially high adherability with respect to the polyimide-based adhesives. The present invention is accomplished based on the finding.

1. A non-thermoplastic polyimide film prepared from a diamine component and an acid dianhydride component, the diamine component containing 2,2-bisaminophenoxyphenylpropane and paraphenylenediamine, and the acid dianhydride component containing pyromellitic dianhydride and 3,3′4,4′-benzophenonetetracarboxylic dianhydride, wherein:

the non-thermoplastic polyimide film has an average birefringence of less than 0.14.

2. The non-thermoplastic polyimide film as set forth in claim 1, wherein the non-thermoplastic polyimide film has an elasticity in a range of 5 to 10 GPa, and an average linear expansion coefficient in a range of 5 to 15ppm when heated from 100° C. to 200° C.

3. The non-thermoplastic polyimide film as set forth in claim 1 or 2 wherein the average birefringence is less than 0.13.

4. The non-thermoplastic polyimide film as set forth in any one of claims 1 to 3, wherein the diamine component contains an oxydianiline.

5. The non-thermoplastic polyimide film as set forth in claim 4, wherein the diamine component contains 2,2-bisaminophenoxyphenylpropane in a range of 10 to 50 mol %, paraphenylenediamine in a range of 30 to 60 mol %, and the oxydianiline in a range of 10 to 30 mol %, with respect to the whole diamine component.

6. The non-thermoplastic polyimide film as set forth in claim 3 or 4, wherein the oxydianiline is 3,4′-oxydianiline or 4,4′-oxydianiline.

7. The non-thermoplastic polyimide film as set forth in any one of claims 1 to 6, wherein the acid dianhydride component contains pyromellitic dianhydride in 60 to 95 mol % and 3,3′4,4′-benzophenonetetracarboxylic dianhydride in a range of 5 to 40 mol % with respect to the whole acid dianhydride component.

[Effect of the Invention]

A polyimide film obtained according to the present invention provides a better adherability, for example, between a metal foil and the polyimide film in producing a flexible metal-clad laminate. More specifically, the present invention, which attains a high adherability, can make it possible to form fine wiring pattern as required by the high-density packaging. Moreover, the polyimide film according to the present invention has a better adherability with respect to a thermoplastic polyimide used as an adhesive, compared with conventional polyimide films that are poor in the adherability with respect to thermoplastic polyimide as an adhesive. Therefore, the present invention can cope with the higher reflow temperature required by lead-free soldering.

### BEST MODE FOR CARRYING OUT THE INVENTION

A polyimide film according to the present invention is arranged to have particularly specified composition and average birefringence, and to be non-thermoplastic. With this composition, an excellent adhesiveness can be attained in laminating, for example, a metal foil and the polyimide film via an adhesive agent. One embodiment of the present invention is described below.

(Composition of Polyimide Film)

In the present invention, the composition of the polyimide film is particularly specified. Monomers from which the polyimide film is produced are explained below. In the present invention, a diamine component should have 2,2-bisaminophenoxyphenylpropane, and paraphenylenediamine. With this arrangement, it is possible to attain an excellent adherability. Moreover, the present invention attains not only an excellent adherability under ordinary conditions, but also an excellent post-PCT (Pressure Cooker Test) adherability. It is preferable that 2,2-bisaminophenoxyphenylpropane, be contained in a range of 30 to 60 mol % and paraphenylenediamine be contained in range of 40 to 70 mol % with respect to the diamine component. With these ranges, the film attains an excellent balance between linear expansion coefficient and birefringence. An amount of the PCT paraphenylenediamine above the range increases later-described elasticity and the birefringence while decreasing the linear expansion coefficient. An amount of 2,2-bisaminophenoxyphenylpropane above the range decreases the elasticity, the birefringence, and water absorption, while increasing the linear expansion coefficient and the adherability. The thus arranged diamine component may further contain oxydianiline in order to have further higher adherability. Thus, it is preferable that the diamine component contain oxydianiline as well. The diamine component further containing oxydianiline tends to show a significantly better bonding strength after PCT. For easily balancing the linear expansion coefficient and birefringence, it is preferable that the diamine component contain 2,2-bisaminophenoxyphenylpropane in a range of 10 to 50 mol %, paraphenylenediamine in a range of 30 to 60 mol %, and oxydianiline in a range of 10 to 30 mol %, with respect to the diamine component. Examples of oxydianiline encompass 4,4′-oxydianiline, 3,4′-oxydianiline, 3,3′-oxydianiline, 2,4′-oxydianiline, etc. Among these, it is preferable to use 3,4′-oxydianiline and/or 4,4′-oxydianiline, because this arrangement makes it easier to attain the object. An acid component should contain pyromellitic dianhydride and 3,3′,4,4′-benzophenonetetracarboxylic dianhydride for attaining an excellent adherability. It is preferable that the acid component contain 3,3′,4,4′-benzophenonetetracarboxylic dianhydride in a range of 60 to 95 mol % and pyromellitic dianhydride in a range of 5 to 40 mol %. Amounts of these dianhydrides out of these ranges result in poor bonding strength and excessively large linear expansion coefficient.

(Average Birefringence)

It is important for the polyimide film of the present invention that it have an average birefringence of less than 0.14. With this arrangement, the polyimide film of the present invention can have an excellent adherability. An average birefringence above the range gives the polyimide film a low bonding strength, or an extremely low post-PCT bonding strength. Such a polyimide film is unsuitable for use in two-layered CCL that requires a high reliability. Therefore, the polyimide film should be designed to have the composition and an average birefringence of less than 0.14. In the present invention, the average birefringence can be determined by working out an average of birefringence in two perpendicularly-crossing directions (i.e., an average of a maximum value and a minimum value of birefringence) according to an extinction angle determined by observing a 2×2 cm film under crossed nicols by using a polarization microscope. The birefringence in the present inventions is a difference between a refractive index in an in-plane direction of a film and a refractive index in a thickness direction of the film. For better adherability, it is preferable that the average birefringence be less than 0.13. Even for a long film,, it is sufficient for the birefringence of the present invention that it is measured from one point in a center portion of the film regardless of how wide the film is.

(Polyimide Film Property)

In addition to the arrangement in terms of the composition and birefringence, it is important that the polyimide film of the present invention be non-thermoplastic. Therefore, the polyimide film should be designed to be non-thermoplastic with the composition. Furthermore, the polyimide film of the present invention has an elasticity preferably in a range of 5 to 10 GPa, and more preferably in a range of 6 to 9 GPa. Elasticity below the range gives poorer dimensional stability to a two-layered CCL to which the polyimide film is employed. Elasticity above the range results in poor flexibility of the polyimide film, which lower the flexibility property of the CCL. Moreover, the polyimide film of the present invention has an average linear expansion coefficient preferably in a range of 5 to 15 ppm, especially preferably in a range of 7 to 13 ppm. Average linear expansion coefficient out of the ranges gives the two-layered CCL in which the polyimide film is employed.

(Production of Polyimide Film)

The polyimide film for use in the present invention is produced from a polyamic acid as a precursor. The polyamide may be produced by any methods known as methods for producing polyamic acid. In general, an aromatic dianhydride and an aromatic diamine in substantially equimolar amounts are dissolved in an organic solvent thereby to prepare a solution in which the polyamic acid is dissolved in the organic solvent. The solution is stirred under controlled temperature condition until polymerization of the acid dianhydride and the diamine is completed. In this way, the polyamic acid is prepared. The polyamic acid solution is obtained at a concentration generally in a range of 5 to 35 wt %, and preferably in a range of 10 to 30 wt %. The polyamic acid solution in this range has an appropriate molecular weight and appropriate solution viscosity. Various known processes and combinations of these processes may be employed as the polymerization process. The key feature of the polymerization process for producing polyamic acid is the order of adding the monomers. The physical properties of the resulting polyimide are adjusted by controlling the order of adding the monomers. Thus, in the present invention, any process of adding monomers may be employed for producing the polyamic acid. Representative examples of the polymerization processes are as follows:

1) After an aromatic diamine component is dissolved in an organic polar solvent, an aromatic tetracarboxylic dianhydride component in an amount substantially equimolar to the aromatic diamine component is added thereto and then the aromatic diamine component and the aromatic tetracarboxylic dianhydride component are reacted to polymerize.

2) An aromatic tetracarboxylic dianhydride component and an aromatic diamine component (in an amount less in mole than the aromatic tetracarboxylic dianhydride component) are dissolved in the organic polar solvent and then reacted with each other, in order to obtain a solution of a prepolymer in the organic polar solvent, the prepolymer having an acid anhydride group on both ends. Next, to the solution of the prepolymer, the aromatic diamine component is added in an amount that makes up the equimolar amount of the aromatic diamine component in an overall process with respect to the aromatic tetracarboxylic dianhydride component. Then polymerization is carried out.

3) An aromatic acid anhydride component and an aromatic diamine component (in an amount greater in mole than the aromatic tetracarboxylic anhydride component) are dissolved and reacted with each other in the organic polar solvent, thereby to obtain a solution of a prepolymer in the organic polar solvent, the prepolymer having an amino group on both ends. Next, to the solution of the prepolymer, the aromatic diamine compound is further added and then the aromatic tetracarboxylic dianhydride component is added in an amount that makes up the equimolar amount of the aromatic tetracarboxylic dianhydride component in an overall process with respect to the aromatic diamine component. Then polymerization is carried out.

4) After an aromatic tetracarboxylic dianhydride component is dissolved and/or dispersed in the organic polar solvent, an aromatic diamine component in an amount substantially equimolar to the aromatic tetracarboxylic dianhydride component is added thereto and then the aromatic tetracarboxylic dianhydride component and the aromatic diamine component are reacted.

5) An aromatic tetracarboxylic dianhydride component and an aromatic diamine component in substantially equimolar amounts are dissolved in the organic polar solvent and reacted for polymerization.

These methods may be employed solely or partially in combination. The polyimide film may be produced from these polyamic acid solutions in any conventionally known methods, which encompass thermal imidization method and chemical imidization method. Either method may be employed to produced the film. However, the chemical imidization method may be more easy to obtain a polyimide film having the various properties that are preferable in the present invention.

In the present invention, it is especially preferable that the production process of the polyimide film include:

a) reacting an aromatic diamine and an aromatic tetracarboxylic dianhydride in an organic solvent, so as to obtain a polyamic acid solution;

b) flow-casting, on a support, a film formation dope containing the polyamic acid solution;

c) heating the film formation dope on the support removing a gel film from the support;

d) further heating the gel film so as to imidize residual amic acid and dry the gel film.

In the above process, a curing agent containing a dehydrating agent or an imidization catalyst. Typical examples of the dehydrating agent include acid anhydrides such as acetic anhydride. Typical examples of the imidization catalyst include tertiary amines such as isoquinoline, β-picoline, pyridine, etc.

In the following, a preferable embodiment is described to explain the production process of the polyimide film. In the embodiment, the chemical imidization is explained for example. It should be noted that the present invention is not limited to the following arrangement described by way of example, and the film formation condition and heating condition may be varied as appropriate according to the kinds of the polyamic acid, film thickness, etc.

For example, the dehydrating agent and imidization catalyst may be added into the polyamic acid solution at a low temperature thereby to preparing a film formation dope. Then, the film formation dope is cast on a support such as a glass board, an aluminum foil, endless stainless steel belt, stainless steel drum, or the like., thereby forming a film thereof on the support. The film on the support is heated in a temperature in arrange of 80° C. to 200° C., preferably in a range of 100° C. to 180° C. in order to activate the dehydrating agent and the imidization catalyst. Thereby, the film is partially cured and/or dried. Then, the film is removed from the support thereby obtaining a polyamic acid film (hereinafter this film is referred to as a gel film). The gel film is in an intermediate state in the curing of the polyamic acid to the polyimide. The gel film is a self-supportive film. A volatile content of the gel film is expressed as formula (1):
(A−B)×100/B (1)
where A is a weight of the gel film, and B is a weight of the gel film after heated at 450° C. for 20 min.

The volatile content of the gel film is in a range of 5 to 500 wt. %, preferably in a range of 5 to 200 wt. %, and more preferably in a range of 5 to 150 wt. %. It is preferable to use a file in these ranges. In a curing process, there is a risk of film breakage, lack of uniformity in color tone of the film due to unevenly drying the film, and property variation, etc. The amount of the dehydrating agent is in a range of 0.5 to 5 mol, and preferably in a range of 1.0 to 4 mol per unit of amid acid in the polyamic acid. Moreover, the amount of the imidization catalyst is in arrange of 0.05 to 3 mol, and preferably in a range of 0.2 to 2 mol per unit of amic acid in the polyamic acid.

The chemical imidization would be insufficient when the amounts of the dehydrating agent and imidization catalyst are below the ranges. The insufficient chemical imidization would results in the film breakage during the curing or low mechanical strength. On the other hand, the imidization would proceed too fast when the amounts of the dehydrating agent and imidization catalyst are above the ranges. The too-fast imidization would make it difficult to cast the solution into the film-like shape.

The gel film held at its ends is dried. By being held at its ends, the gel film can avoid the shrinkage due to the curing. The drying removes water, residual solvent, residual converting agent, and catalyst from the film, and completes the imidization of the residual amid acid. Thereby, the polyimide film of the present invention can be obtained. The drying is preferably carried out at a temperature in a range of 400 to 650° C. for a time period in a range of 5 to 400 sec. Drying carried out at a temperature higher than the range and/or for a time period longer than the range would possibly cause thermal deterioration in the film. On the other hand, drying carried out at a temperature lower than the range and/or for a time period shorter than the range would possibly fail to attain the desired effect. Moreover, the heat treatment of the film may be carried out with the film stretched at a lowest tension necessary for conveying the film. This lowers an internal stress remained in the film. The heat treatment may be carried out during the film production process, or may be carried out in addition to the process. The heating condition cannot be specified because the heating condition varies depending on film property or apparatus to use. The internal stress can be alleviated by heating at a temperature generally not less than 200° C. but not more than 500° C., preferably not less than 250° C. but not more than 500° C., especially preferably not less than 300° C. but not more than 450° C., for a time period in a range of 1 to 300 sec, preferably in a range of 2 to 250 sec, and especially preferably in a range of 5 to 200 sec. Moreover, the film may be stretched before or after the fixing the gel film to the frame. For this stretching, the film has a volatile content in a range of 100 to 500 wt. %, and preferably in a range of 150 to 500 wt. %. Volatile content below the range would make it difficult to stretch the film. Volatile content above the range causes the film to be poor in self-supporting property, which makes it difficult the stretching operation. The stretching operation may be carried out by using any known method, encompassing a method using differential rollers, a method widening a gap of a tenter, etc. Moreover, the average birefringence of the polyimide film of the present invention is less than 0.14 and preferably less than 0.13. The average birefringence of the polyimide film of the present invention may be controlled in any way. Average birefringence varies depending on factors such as kinds of monomer used, polymerization method, and film formation conditions. Furthermore, difference combinations of these factors result in different average birefringence. Therefore, the average birefringence cannot be specified by a production method in general. However, birefringence can be controlled by the following production method for example. It is easy to measure the birefringence (average birefringence) of the film, as described above. Designing of a desired film may be carried out by measuring birefringence of films prepared considering the following tendency of the average birefringence.

1) Prepare films with monomers used in different compositional ratios (A film tends to have a larger average birefringence when the film is prepared with a larger amount of paraphenyleneamine and a smaller amount of 2,2-bis(aminophenoxyphenyl)propane in their compositional ratio. A film tends to have a smaller average birefringence when the film is prepared with a larger amount of 3,3′,4,4′-benzophenonetetracarboxylic dianhydride in the compositional ratio.)

2) Prepare films by performing the polymerization by adding the monomers in different orders. For example, a film tends to have a large average birefringence, when it is prepared by adding the monomers in such an order that paraphenylenediamine and pyromellitic dianhydride are reacted selectively. Meanwhile, a film tends to have a small average birefringence, when it is prepared by adding the monomers in such an order that 2,2-bis(aminophenoxyphenyl)propane and 3,3′,4,4′-benzophenonetetracarboxylic dianhydride are selectively reacted.

3) Prepare films under different film formation conditions. For example, a film tends to have a smaller average birefringence, when it is prepared with low volatile content and arranging a step for heating a gel film held at its edge at programmed temperatures such that a first temperature step is low. Moreover, the average birefringence can be controlled by designing the combination of the volatile content in the gel film and the first temperature step of the programmed temperatures. Therefore, by trying various combinations of the volatile content and heating condition for a polyamic acid solution to be used, the volatile content and the heating condition appropriate to obtain the desired polyimide film can be determined.

4) Prepare films with different amounts of dehydrating agent and imidization catalyst. For example, a smaller amount of the dehydrating agent and/or imidization catalyst tends to result in smaller average birefringence.

5) Prepare films by arranging film formation process such that the film formation process is carried out while the film is stretched. For example, if the film formation process is carried out while the film is stretched at a large stretching ratio, the average birefringence will be larger. If the film formation process is carried out while the film is allowed to shrink, the average birefringence will be smaller.

6) Prepare films by arranging the step for heating the gel film held at its edges such that temperature steps and temperature increasing rate(s) are controlled. The inventors of the present invention found that average birefringence of different polyamic acid solutions (different in composition and polymerization method, etc.) are differently influenced from the temperature conditions in the step for heating the gel film held at its edges. That is, a slow temperature increasing rate tends to give a smaller average birefringence for some polyamic acid solutions, but gives greater average birefringence for the others. Therefore, various heating conditions should be tried on the polyamic acid solution to use, in order to find a temperature profile suitable for obtaining the desired polyimide film.

7) Prepare films employing the above-mentioned conditions in combination appropriately

Any solvents in which the polyimide precursor (hereinafter, referred to as the polyamic acid) is soluble can be preferably used as the solvent for the synthesis of the polyamic acid. Amide-based solvents, such as N,N-dimethylformamide, N,N-dimethylacetoamide, N-methyl-2-pyrorridone, may be used as the solvent. Especially, N,N-dimethylformamide, and N,N-dimethylacetoamide are preferable. Moreover, a filler may be added in order to attain better film properties such as slidability, heat conductivity, electric conductivity, corona resistance, loop stiffness, etc. Any kind of filler may be used. Preferable examples of the filler encompass silica, titanium oxide, alumina, silicon nitride, boron nitride, dibasic calcium phosphate, calcium phosphate, mica, and the like.

The diameter of the filler particles may be determined based on the film properties to be modified and the type of filler, and is thus not particularly limited. The average particle diameter is usually 0.05 to 100 μm, preferably 0.1 to 75 μm, more preferably 0.1 to 50 μm, and most preferably 0.1 to 25 μm. When the average diameter is below this range, the effect of modification is not readily exhibited. At an average diameter beyond this range, the surface quality and/or the mechanical properties may be significantly degraded. The amount of the filler to be added is determined based on the film properties to be modified and the diameter of the filler particles and is thus not particularly limited. The amount of the filler added is usually 0.01 to 100 parts by weight, preferably 0.01 to 90 parts by weight, and more preferably 0.02 to 80 parts by weight per 100 parts by weight of polyimide. At a filler content below this range, the effect of the modification by the use of the filler may not be sufficiently exhibited. At a filler content beyond this range, the mechanical properties of the film may be significantly degraded.

The filler may be added by any method. The examples of the method include:

1. Method of adding the filler to the polymerization solution before or during the polymerization;

2. Method of adding and kneading the filler into the polymerization solution with a three-shaft roller after completion of the polymerization; and

3. Method including preparing a dispersion containing the filler in advance and adding the dispersion into a polyamic acid organic solvent solution.

Any method may be employed for the addition of the filler. However, the method including preparing a dispersion containing the filler in advance and adding the dispersion into a polyamic acid organic solvent solution, especially right before the film formation is preferable because contamination of the production line with the filler in this method is least severe. In the preparation of the dispersion, it is preferable to use the same solvent as the polymerization solvent of the polyamic acid. In order to sufficiently disperse the filler and stabilize the dispersion state, a dispersant, a thickener, or the like may be used in amounts that do not adversely affect the properties of the film.

For example, the polyimide film of the present invention thus obtained is excellent in adherability under ordinary conditions in the case where the metal foil is applied on the film by using an adhesive, but also in the post-PCT test conditions. Especially, the polyimide film of the present invention thus obtained shows good adherability with respect to polyimide-based adhesive agents. However, the polyimide film of the present invention thus obtained can show adherability with respect to adhesive agents other than the polyimide-based adhesive agents. Moreover, metal may be directly applied to the polyimide film of the present invention thus obtained.

### EXAMPLE

The present invention is more specifically explained below referring to Examples. It should be noted that the present invention is not limited to these Examples.

In Examples and Comparative Examples, average birefringence, elasticity, linear expansion coefficient, and adherability were evaluated as bellow.

(Average Birefringence)

A film piece of 2×2 cm was observed under crossed nicols by using a polarization microscope (OPTIPHOT·POL, made by Nippon Kogakusha), thereby to find an extinction angle. Based on the extinction angle, an average birefringence in two direction crossing each other at the right angle (that is, an average of largest and smallest values of the birefringence) was obtained. In the present invention, the birefringence is a difference between a refractive index in an in-plane direction and a refractive index in a thickness direction.

The birefringence was measured by using (i) a refractometer (4T type, made by Atago Co., Ltd.) provided with an eye pieces having a polarizer and (ii) a Na lamp as a light source.

(Adherability Evaluation)

Surfaces of a polyimide film were pretreated with corona density of 200W min/m². A polyamic acid solution prepared in Reference Example 1 was diluted with DMF to 10 wt. % solid content. On both the surfaces of the polyimide film, a polyamic acid was applied so that a thermoplastic polyimide layer (adhesive layer) would be finally 4 μm in thickness on one side. The film was heated at 140° C. for 1 min. Subsequently, the film was passed through a far-infrared heater furnace for 20 sections for thermal imidization. The far-infrared ray heater furnace had an atmospheric temperature of 390° C. Thereby an adhesive film was obtained. On each side of the thus prepared adhesive film, a 18 μm rolled copper foil (BHY-22B-T, Japan Energy Corp.) and a protective material (Apical 125 NPI, Kaneka Corp.) on top of each copper foil were thermally laminated at lamination temperature of 360° C., lamination pressure of 196 N/cm (20 kgf/cm), and lamination rate of 1.5 m/min, thereby obtaining an FCCL.

According to JIS C6471 “6.5 Peel Strength”, samples were prepared from this FCCL. Measured was a load to peel off a metal foil portion of 5 mm width at peeling angle of 180 degrees at 50 mm/min. Further, bonding strength of a sample subjected to a pressure cooker test (PCT) in which the sample was subjected to a temperature of 121° C. under 100% RH for 96 hours was also measured.

(Elasticity)

Elasticity was measured in accordance with ASTM D882.

(Linear Expansion Coefficient)

The linear expansion coefficient when heated from 50° C. to 200° C. was measured with a thermomechanical analyzer TMA120C produced by Seiko Instruments Inc. The linear expansion coefficient was measured as follows: A sample (3 mm in width and 10 mm in length) was heated from 10° C. to 400° C. at a rate of 10° C./min under a load of 3 g. Then, the sample was cooled to 10° C., and again heated at 10° C./min. The thermal expansion coefficients at 50° C. and 200° C. measured during the second heating were averaged to determine the linear expansion coefficient.

(Plasticity Evaluation)

The plasticity was evaluated by holding a prepared film of 20×20 cm to a frame made of SUS in a square shape (outer frame 20×20 cm, inner frame 18×18 cm), and then heating the film at 450° C. for 3 min. Films which maintained their shapes after the heat treatment were judged as non-thermoplastic, while films which shrank or extended were judged as thermoplastic.

### REFERENCE EXAMPLE

### Synthesis of the Thermoplastic Polyimide Precursor

Into a glass flask of 2000 ml in volume, 780 g of DMF, and 115.6 g of 2,2-bis[4-(4-aminophenoxy)phenyl]propane(BAPP) were added. Then, 78.7 g of 3,3′4,4′-biphenyltetracarboxylic dianhydride (BPDA) was added thereto under stirring in a nitrogen atmosphere. After that, 3.8 g of ethylenebis(trimellitic acid monoester anhydride) (TMEG) was added thereto. Then, a mixture thus prepared was stirred in an ice bath for 30 min, thereby obtaining a reaction solution. A solution in which 2.0 g of TMEG was dissolved in 20 g of DMF was separately prepared. While monitoring viscosity, the solution was added to the reaction solution gradually under stirring. When the viscosity reached 3000 poise, the addition and stirring were stopped. Thereby, a polyamic acid solution was obtained. The polyamic acid solution was flow-cast on a 25 μm PET film (Cerapeel HP, produced by Toyo Metallizing Co., Ltd.) so that the final thickness would be 20 μm, and dried at 120° C. for 5 minutes. The resulting self-supporting film after the drying was peeled from the PET film, fixed onto a metal pin frame, and dried at 150° C. for 5 minutes, at 200° C. for 5 minutes, at 250° C. for 5 minutes, and at 350° C. for 5 minutes to give a single-layer sheet. The glass transition temperature of the thermoplastic polyimide was 240° C.

### COMPARATIVE EXAMPLE 1

Into 546 g of N,N-dimethylformamide (DMF), which was cooled to 10° C., 46.43 g of 2,2-bis(4-aminophenoxyphenyl)propane (BAPP) was dissolved. Then, 9.12 g of 3,3′4,4′-benzophenonetetracarboxylic dianhydride (BTDA) was added and dissolved therein. After that, Then, 16.06 g of pyromellitic dianhydride (PMDA) was added and the resulting mixture was stirred for 30 minutes to obtain a prepolymer. After 18.37 g of p-phenylenediamine (p-PDA) was dissolved into this solution, 37.67 g of PMDA was added and dissolved therein by 1-hour stirring. Then, a separately-prepared DMF solution of PMDA (in which 1.85 g of PMDA was dissolved in 24.6 g of DMF) was carefully added to the thus prepared solution until viscosity of the solution reached 3000 poise approximately. The solution was stirred for 1 hour. Thereby, a polyamic acid solution of 19 wt. % in solid content and 3400 poise in rotational viscosity at 23° C.

To 100 g of this polyamic acid solution, 50 g of a curing agent composed of acetic anhydride/isoquinoline/DMF (ratio of 18.90/7.17/18.93 based on weight) was added, and the resulting mixture was stirred and degassed at a temperature of 0° C. or lower. The mixture was then flow-cast on an aluminum foil using a comma coater. This resin film was heated at 130° C. for 100 seconds. The resulting self-supporting gel film (residual volatile component content: 45 wt %) was peeled from the aluminum foil, fixed on a metal frame, and dried at 300° C. for 20 seconds, 400° C. for 20 seconds, and 500° C. for 20 seconds for imidization to obtain a polyimide film having a thickness of 18 μm. The film properties and the adhesive properties of the film obtained are shown in Table 1.

### EXAMPLE 1

A polyimide film of 18 μm was obtained in the same manner as in Comparative Example 1, except that a curing agent composed of acetic anhydride/isoquinoline/DMF (ratio of 14/5/30 based on weight), and the drying the film on the aluminum foil was carried out at 150° C. for 70 sec. A gel film in Example 1 was 46 wt % in volatile content. The film properties and the adhesive properties of the film obtained are shown in Table 1.

### EXAMPLES 2 AND 3

A polyimide film was obtained in the same manner as in Example 1, except that the polymerization was initiated by dissolving BAPP and 3,4′-ODA into DMF, instead of initiating the polymerization by dissolving 10° C.-cooled N,N-dimethylformamide (DMF) into BAPP, and that the monomers were added in a different compositional ratios. The film properties and the adhesive properties of the film obtained are shown in Table 1.

### EXAMPLE 4

A polyimide film was obtained in the same manner as in Example 1, except that the polymerization was initiated by dissolving BAPP and 4,4′-ODA into DMF, instead of initiating the polymerization by dissolving 10° C.-cooled N,N-dimethylformamide (DMF) into BAPP, and that the monomers were added in a different compositional ratios. The film properties and the adhesive properties of the film obtained are shown in Table 1.

### COMPARATIVE EXAMPLE 2

A polyimide film was prepared in the same manner as in Comparative Example, except that the monomers were added in a different ratio. The film properties and the adhesive properties of the film obtained are shown in Table 2.

### COMPARATIVE EXAMPLE 3

A film was evaluated, which was prepared according to Example 1 in Japanese Unexamined Patent Application Publication, No. 2000-80178. That is, 150 ml of DMAc was introduced in a glass flask of 500 cc. Then, p-PDA was dissolved therein. Sequentially, BAPP, BTDA, and PMDA were added in this order. The solution thus prepared was stirred at a room temperature for about 1 hour. Then, acetic dianhydride of 1 mol % with respect to diamine component was added therein. The solution was stirred for 1 hour again. Thereby, a solution containing a polyamic acid by 20 wt. % was obtained. The polyamic acid had a molar ratio of p-PDA/BAPP/BTDA/PMDA=75/25/25/75. The 60 g of co-polymerized polyamic acid solution was mixed with 25.4 ml DMAc, 7.2 ml of acetic anhydride, and 7.2 ml of β-picoline, and then stirred and degassed as a temperature of 0° C. or less. Then, the solution was flow-cast on a glass board by using a comma coater. The glass board was heated for about 4 min on a hot plate of 150° C., thereby forming a self-supportive gel film. The gel film (volatile content of 30 wt. %) was peeled off from the glass board and then fixed to a metal frame. The gel film was then heated at temperatures programmed to increase from 250° C. to 330° C. for 30 min, and then stay at 400° C. for about 5 min. Thereby, a polyimide film of approximately 25 μm in thickness was obtained. The film properties and the adhesive properties of the film obtained are shown in Table 2.

### COMPARATIVE EXAMPLE 4

A film was evaluated, which was prepared according to Example 2 in Japanese Unexamined Patent Application Publication, No. 2000-80178. That is, a glass flask of 500 cc, 150 ml of DMAc was introduced. Then, p-PDA was dissolved therein. Sequentially, PMDA were added in this order. The solution thus prepared was stirred at a room temperature for about 1 hour. To the solution, BAPP was added and completely dissolved. After BTDA was added therein, the solution was stirred at room temperature for about 1 hour. Then, acetic dianhydride of 1 mol % with respect to diamine component was added therein. The solution was stirred for 1 hour again. Thereby, a solution containing a polyamic acid by 20 wt. % was obtained. The polyamic acid had a molar ratio of p-PDA/BAPP/BTDA/PMDA=50/50/50/50. From this solution, a polyimide film of approximately 25 μm was prepared in the same manner as in Comparative Example 3. The film properties of the film obtained are shown in Table 1.

TABLE 1

| | | Example 1 | | Example 2 | | Example 3 | | Example 4 | |
|---|---|---|---|---|---|---|---|---|---|
| Order of | 1 | BAPP | 40 | BAPP | 30 | BAPP | 30 | BAPP | 30 |
| adding | 2 | BTDA | 10 | 3,4′ODA | 20 | 3,4′ODA | 20 | 4,4′ODA | 20 |
| Monomers | 3 | PMDA | 26 | BTDA | 10 | BTDA | 20 | BTDA | 20 |
| | 4 | PDA | 60 | PMDA | 35 | PMDA | 25 | PMDA | 22.5 |
| | 5 | PMDA | 64 | PDA | 50 | PDA | 50 | PDA | 50 |
| | 6 | | | PMDA | 55 | PMDA | 55 | PMDA | 52.5 |

| Thermoplastisity | | Non | Non | Non | Non |
|---|---|---|---|---|---|
| Evaluation | | | | | |
| Elasticity GPa | | 5.9 | 7.1 | 7.0 | 6.8 |
| Linear Expansion | | 15 | 10 | 13 | 12 |
| Coefficient | | | | | |
| Average | | 0.134 | 0.129 | 0.120 | 0.138 |
| Birefringence | | | | | |
| Adhesion | Normal | 10.9 | 15.1 | 18.1 | 14.5 |
| Strength | Post- | 5.1 | 13.0 | 16.4 | 14.0 |
| | PCT | | | | |

Abbreviation: “Non” indicates that the polyimide was non-thermoplastic.

TABLE 2

| | | Comparative | | Comparative | | Comparative | | Comparative | |
|---|---|---|---|---|---|---|---|---|---|
| | | Example 1 | | Example 2 | | Example 3 | | Example 4 | |
| Order of | 1 | BAPP | 40 | PDA | 50 | PDA | 75 | PDA | 50 |
| adding | 2 | BTDA | 10 | PMDA | 45 | BAPP | 25 | PMDA | 50 |
| Monomers | 3 | PMDA | 26 | BAPP | 50 | BTDA | 25 | BAPP | 50 |
| | 4 | PDA | 60 | PMDA | 55 | PMDA | 75 | BTDA | 50 |
| | 5 | PMDA | 64 | | | | | | |

| Thermoplastisity | | Non | Non | Non | Thermo |
|---|---|---|---|---|---|
| Evaluation | | | | | |
| Elasticity GPa | | 7.3 | 6.2 | 6.3 | — |
| Linear Expansion | | 11 | 14 | 11 | — |
| Coefficient | | | | | |
| Average | | 0.145 | 0.141 | 0.150 | — |
| Birefringene | | | | | |
| Adhesion | Normal | 7.5 | 3.9 | 6.5 | — |
| Strength | Post- | 2.0 | 2.5 | 1.3 | — |
| | PCT | | | | |

Abbreviation: “Non” indicates that the polyimide was non-thermoplastic; “Thermo” indicates that the polyimide was thermoplastic.

### INDUSTRIAL APPLICABILITY

A polyimide film obtained according to the present invention provides a better adherability, for example, between a metal foil and the polyimide film in producing a flexible metal-clad laminate. More specifically, the present invention, which attains a high adherability, can make it possible to form fine wiring pattern as required by the high-density packaging. Moreover, the polyimide film according to the present invention has a better adherability with respect to a thermoplastic polyimide used as an adhesive, compared with conventional polyimide films that are poor in the adherability with respect to thermoplastic polyimide as an adhesive. Therefore, the present invention can cope with the higher reflow temperature required by lead-free soldering.

1. A non-thermoplastic polyimide film prepared from a diamine component and an acid dianhydride component, the diamine component containing 2,2-bisaminophenoxyphenylpropane and paraphenylenediamine, and the acid dianhydride component containing pyromellitic dianhydride and 3,3′,4,4′-benzophenonetetracarboxylic dianhydride, wherein:
the non-thermoplastic polyimide film has an average birefringence of less than 0.14.

2. The non-thermoplastic polyimide film as set forth in claim 1, wherein the non-thermoplastic polyimide film has an elasticity in a range of 5 to 10 GPa, and an average linear expansion coefficient in a range of 5 to 15 ppm when heated from 100° C. to 200° C.

3. The non-thermoplastic polyimide film as set forth in claim 1 wherein the average birefringence is less than 0.13.

4. The non-thermoplastic polyimide film as set forth in claim 1, wherein the diamine component contains an oxydianiline.

5. The non-thermoplastic polyimide film as set forth in claim 4, wherein the diamine component contains 2,2-bisaminophenoxyphenylpropane in a range of 10 to 50 mol %, paraphenylenediamine in a range of 30 to 60 mol %, and the oxydianiline in a range of 10 to 30 mol %, with respect to the whole diamine component.

6. The non-thermoplastic polyimide film as set forth in claim 4, wherein the oxydianiline is 3,4′-oxydianiline or 4,4′-oxydianiline.

7. The non-thermoplastic polyimide film as set forth in claim 1, wherein the acid dianhydride component contains pyromellitic dianhydride in 60 to 95 mol % and 3,3′,4,4′-benzophenonetetracarboxylic dianhydride in a range of 5 to 40 mol % with respect to the whole acid dianhydride component.

8. The non-thermoplastic polyimide film as set forth in claim 2 wherein the average birefringence is less than 0.13.

9. The non-thermoplastic polyimide film as set forth in claim 2, wherein the acid dianhydride component contains pyromellitic dianhydride in 60 to 95 mol % and 3,3′,4,4′-benzophenonetetracarboxylic dianhydride in a range of 5 to 40 mol % with respect to the whole acid dianhydride component.
